(19) United States
(12) Patent Application Publication
(10) Pub. No.: US 2024/0333114 A1
(43) Pub. Date: Oct. 3, 2024

(54) ROTOR FOR AN INDUCTION MOTOR AND A METHOD OF MANUFACTURING THE SAME

(71) Applicants: HYUNDAI MOTOR COMPANY, Seoul (KR); KIA CORPORATION, Seoul (KR)

(72) Inventors: Myoung Ho Lee, Suwon-si (KR); Seok Ha, Anyang-si (KR); Sug Won Heo, Suwon-si (KR)

(73) Assignees: HYUNDAI MOTOR COMPANY, Seoul (KR); KIA CORPORATION, Seoul (KR)

(21) Appl. No.: 18/237,436

(22) Filed: Aug. 24, 2023

(30) Foreign Application Priority Data
Mar. 27, 2023 (KR) 10-2023-0039743

(51) Int. Cl. H02K 17/16; H02K 1/02; H02K 1/26; H02K 15/00

(52) U.S. Cl. CPC H02K 17/16; H02K 1/02; H02K 1/26; H02K 15/0012

(57) ABSTRACT

Disclosed are a rotor for an induction motor including a conductor bar made of an aluminum-copper composite material and a method of manufacturing the rotor using casting and a high-frequency induction heating brazing method.

### CROSS-REFERENCE TO RELATED APPLICATION

This application claims, under 35 U.S.C. § 119 (a), the benefit of and priority to Korean Patent Application No. 10-2023-0039743, filed on Mar. 27, 2023, the entire contents of which are incorporated herein by reference.

### BACKGROUND

### (a) Technical Field

The present disclosure relates to a rotor for an induction motor including a conductor bar made of an aluminum-copper composite material, and a method of manufacturing the rotor using casting and a high-frequency induction heating brazing method.

### (b) Background Art

Vehicle electrification is a process of powering a vehicle with electricity, and vehicle electrification technology has emerged as a major technology in the automobile industry. Particularly, an induction motor is attracting a lot of attention as a rare-earth-free motor to replace a permanent magnet synchronous motor (PMSM). Research is being actively conducted to improve performance of the induction motor, such as torque density and efficiency.

In general, the induction motor includes a stator fixedly installed in a motor housing or a frame, a rotor rotatably inserted into the stator, and a rotating shaft press-fitted into the central portion of the rotor. Here, the rotor may include a plurality of conductor bars formed of a plurality of stacked circular steel plates and respectively inserted into a plurality of slots spaced apart from each other at regular intervals in the radial direction from the central portion of the rotor into which the rotating shaft is press-fitted. In such a conventional induction motor, when current is alternately applied to the stator, induced magnetism is generated by the current flowing through the stator. Accordingly, the rotor may be rotated by interaction with the induced magnetism generated in this way, and the load may be rotated by rotating the rotating shaft according to the rotation of the rotor.

Most of these conventional induction motors use a single aluminum or copper material for the rotating conductor bar. Here, aluminum has the advantage of reducing the conductor bar with its lightweight, but the electrical conductivity of aluminum is about 60% that of copper, which causes deterioration in motor efficiency. On the other hand, copper has excellent electrical conductivity, but the same is three times heavier than aluminum.

In order to solve the above-described problems, efforts have been made to implement a conductor bar using different types of metal. However, since individual processing methods are complicated and economic feasibility thereof is low, it is still difficult to commercialize the above-mentioned conductor bar.

The above information disclosed in this Background section is provided only to enhance understanding of the background of the disclosure. Therefore, the Background section may contain information that does not form the prior art already known to a person of ordinary skill in the art.

### SUMMARY

The present disclosure has been made in an effort to solve the above-described problems associated with the prior art. It is an object of the present disclosure to provide a rotor for an induction motor including a conductor bar made of an aluminum-copper composite material.

Further, an object of the present disclosure is to provide a method of manufacturing the rotor for the induction motor using casting and a high-frequency induction heating brazing method.

The objects of the present disclosure are not limited to the above-mentioned objects, and other technical objects not mentioned herein should be clearly understood by those having ordinary skill in the art from the detailed description of the embodiment, and should be realized by means described in the claims and a combination thereof.

In one aspect of the present disclosure, a rotor for an induction motor includes a rotor core including a body part having a hollow cylindrical shape and a plurality of slots disposed at predetermined intervals along an outer circumferential surface of the body part. In particular, the plurality of slots is formed to be recessed toward a rotation axis of the body part in a predetermined area thereof extending from one end of the body part to the other end thereof. The rotor further includes a conductor bar having a rod shape with a predetermined length corresponding to an inner circumferential surface of the slot, each of the conductor bars being inserted into a corresponding one of the plurality of slots, a first end ring coupled to one side of the rotor core, wherein the first end ring has a ring shape and a communication hole configured to allow the rotation axis to pass through a central portion thereof, and a second end ring formed to be symmetrical to the first end ring and coupled to the other side of the rotor core.

The conductor bar includes a wick containing a first metal and having a predetermined shape and a sealing layer containing a second metal and surrounding an entire surface of the wick.

In an embodiment, the first metal may be aluminum (Al), and the second metal may be copper (Cu).

In another embodiment, the impedance of the conductor bar may be in a range of 0.11 to 0.23 mΩ.

In another embodiment, the average density of the conductor bar may be in a range of 2.8 to 8.9 g/cm³.

In another embodiment, the conductor bar may further include a filler metal at one end and the other end thereof in a longitudinal direction.

In another embodiment, the melting point of the filler metal may be in a range of 750 to 800° C.

In another embodiment, the conductor bar may protrude by a predetermined length from opposite ends of the body part in a direction of the rotation axis, the first end ring may include a first recessed groove formed to be recessed corresponding to one end of the protruding conductor bar, and the second end ring may include a second recessed groove formed to be recessed corresponding to the other end of the protruding conductor bar.

In another embodiment, the conductor bar may protrude by a predetermined length from opposite ends of the body part in a direction of the rotation axis, and the protruding conductor bar may further include a filler metal at one end and the other end thereof. The first end ring may include a first through groove formed to pass therethrough corresponding to the one end of the protruding conductor bar, and the second end ring may include a second through groove formed to pass therethrough corresponding to the other end of the protruding conductor bar.

In another embodiment, the wick may have a plate shape having a predetermined length and a predetermined width. Further, the wick may have a length equal to or shorter than the length from the one side of the rotor core to the other side thereof, and the wick may have a width equal to or smaller than the depth of the slot.

In another aspect, the present disclosure provides a method of manufacturing a rotor for an induction motor. The method includes preparing a rotor core including a body part having a hollow cylindrical shape and a plurality of slots disposed at predetermined intervals along an outer circumferential surface of the body part. In particular, the plurality of slots is formed to be recessed toward a rotation axis of the body part in a predetermined area thereof extending from one end of the body part to the other end thereof. The method further includes: preparing a conductor bar having a rod shape with a predetermined length corresponding to an inner circumferential surface of the slot, each of the conductor bars being inserted into a corresponding one of the plurality of slots, disposing each of the conductor bars in the corresponding one of the plurality of slots, and coupling a first end ring having a ring shape and a communication hole configured to allow the rotation axis to pass through a central portion thereof to one side of the rotor core, and coupling a second end ring formed to be symmetrical to the first end ring to the other side of the rotor core.

Since the conductor bar and the filler metal in the method are the same as in the above-described rotor device, descriptions of common contents therebetween are omitted in order to avoid overly complicating the specification.

In another embodiment, preparing the conductor bar may include preparing a mold containing the second metal, and forming the wick by injecting the first metal into the mold using a low-pressure casting method.

In another embodiment, the disposing may further include applying a filler metal to one end of the conductor bar and the other end thereof in a longitudinal direction.

In another embodiment, the disposing may further include applying a filler metal to one end of the conductor bar and the other end thereof in a longitudinal direction. In particular, the conductor bar may protrude by a predetermined length from opposite ends of the body part in a direction of the rotation axis, the first end ring may include a first through groove formed to pass therethrough corresponding to the one end of the protruding conductor bar, and the second end ring may include a second through groove formed to pass therethrough corresponding to the other end of the protruding conductor bar.

In another embodiment, the coupling may be performed by a high-frequency induction heating brazing method.

In another embodiment, the coupling may be performed within a range of 10 to 20 minutes.

In another embodiment, the coupling may be performed by a high-frequency induction heating brazing method within a range of 10 to 20 minutes.

Other aspects and embodiments of the disclosure are discussed below.

Terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only. Thus, the above and other features of the present disclosure are not limitative of the present disclosure, and wherein:

FIG. 1 is a schematic diagram showing a rotor for an induction motor according to an embodiment of the present disclosure;

FIG. 2 is a side exploded view of the rotor for the induction motor according to an embodiment of the present disclosure;

FIG. 3 is a side sectional view of a rotor core of the rotor for the induction motor according to an embodiment of the present disclosure;

FIG. 4A is a horizontal sectional view (A-A′) of a conductor bar according to an embodiment of the present disclosure;

FIG. 4B is an axial sectional view (B-B′) of the conductor bar according to an embodiment of the present disclosure;

FIG. 5A is an axial sectional view (B-B′) of the rotor core into which the conductor bar is inserted according to the embodiment of the present disclosure;

FIG. 5B is a top view of the rotor for the induction motor into which the conductor bar is inserted according to an embodiment of the present disclosure;

FIG. 5C is a top view in which the conductor bar is removed from a first end ring of the rotor for the induction motor in an embodiment of the present disclosure;

FIG. 6A is a perspective view of a first end ring according to one specific embodiment of the present disclosure;

FIG. 6B is a perspective view of a first end ring according to another specific embodiment of the present disclosure;

FIG. 7A is a flowchart showing a method of manufacturing the rotor for the induction motor according to an embodiment of the present disclosure;

FIG. 7B is a flowchart showing steps of preparing the conductor bar according to an embodiment of the present disclosure;

FIGS. 8A-8F show each step included in the method of manufacturing the rotor for the induction motor according to an embodiment of the present disclosure;

FIGS. 9A-9C show conditions and results of measuring a loss distribution for each conductor bar of the rotor for the induction motor; and

FIGS. 10A-10C show conditions and results of measuring a current density for each conductor bar of the rotor for the induction motor.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes are determined in part by the particular intended application and use environment.

In the figures, reference numbers refer to the same or equivalent parts of the present disclosure throughout the several figures of the drawing.

### DETAILED DESCRIPTION

The above-described objects, other objects, features, and advantages of the present disclosure should be understood through the following embodiments with reference to the accompanying drawings. However, the present disclosure is not limited to the embodiments described herein and may be embodied in many different forms. Rather, the embodiments described herein are provided so that this disclosure is thorough and complete, and fully conveys the scope of the disclosure to those having ordinary skill in the art.

Similar reference numerals are used for similar components throughout the description of each drawing. In the accompanying drawings, the dimensions of the structures are exaggerated for clarity of the present disclosure. Terms such as “first” and “second” may be used to describe various components, but the components should not be limited by the terms. The terms are only used for the purpose of distinguishing one component from another. For example, a first component may be referred to as a second component, or similarly, a second component may be referred to as a first component, without departing from the scope of the present disclosure. Singular expressions include plural expressions unless the context clearly dictates otherwise.

It should be understood that the terms such as “comprises” or “have”, when used in this specification, are intended to specify the presence of stated features, numbers, steps, operations, components, parts, or any combination thereof, but do not preclude the presence or addition of one or more other features, numbers, steps, operations, components, parts, or any combination thereof. When a layer, a film, a region, a plate, or the like is disposed “on” something, it does not necessarily mean that the layer, the film, the region, the plate, or the like is “directly on” the thing and another thing may be interposed between the layer, the film, the region, the plate, or the like and the thing. Conversely, when a layer, a film, a region, a plate, or the like is disposed “below” something, it means not only that the layer, the film, the region, the plate, or the like is “directly below” the thing, but also that another component is interposed between the layer, the film, the region, the plate, or the like and the thing.

Unless otherwise indicated, all numbers, values and/or expressions referring to quantities of ingredients, reaction conditions, polymer compositions, and formulations used herein should be understood as modified in all instances by the term “about” as such numbers are inherently approximations that are reflective of, among other things, the various uncertainties of measurement encountered in obtaining such values. Further, where a numerical range is disclosed herein, such range is continuous and includes, unless otherwise indicated, every value from the minimum value up to and including the maximum value of such range. Still further, where such a range refers to integers, unless otherwise indicated, every integer from the minimum value up to and including the maximum value is included.

In this specification, when a range is described for a variable, it should be understood that the variable includes all values within the described range including the described endpoints of the range. For example, it should be understood that the range of “5-10” includes values of 5, 6, 7, 8, 9, and 10, as well as any subrange such as 6-10, 7-10, 6-9, and 7-9 and any value between valid integers within the scope of the described range, such as 5.5, 6.5, 7.5, 5.5-8.5, and 6.5-9. Further, for example, it should be understood that the range of “10%-30%” includes values such as 10%, 11%, 12%, 13%, and the like, and all integers up to and including 30%. It should be understood that “10%-30%” also includes any subrange such as 10%-15%, 12%-18%, 20%-30%, and the like and any value between valid integers within the scope of the described range, such as 10.5%, 15.5%, 25.5%, and the like.

When a component, device, element, or the like, of the present disclosure, is described as having a purpose or performing an operation, function, or the like, the component, device, or element should be considered herein as being “configured to” meet that purpose or to perform that operation or function.

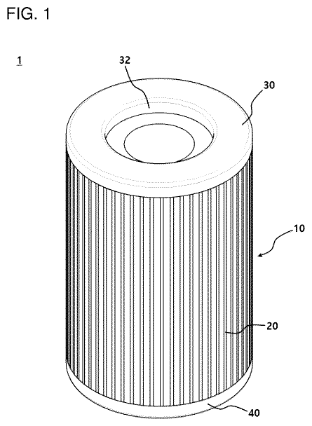

FIG. 1 is a schematic diagram showing a rotor for an induction motor according to an embodiment of the present disclosure.

Referring to FIG. 1, a rotor 1 for an induction motor 1 according to the embodiment of the present disclosure may include a rotor core 10 including a plurality of slots, and a conductor bar 20 having a bar shape with a predetermined length corresponding to the inner circumferential surface of the slot. In particular, each of the conductor bars 20 is inserted into a corresponding one of the plurality of slots. The rotor 1 further includes a ring-shaped first end ring 30 coupled to one side of the rotor core 10, and the first end ring 30 has a communication hole 32 configured to allow a rotation axis to pass through the central portion thereof. The rotor 1 includes a second end ring 40 symmetrical to the first end ring 30 and coupled to the other side of the rotor core 10.

The rotor 1 has excellent electrical conductivity compared to a rotor into which a conductor bar made of a single aluminum material is inserted. The rotor 1 is about 45% lighter than a rotor with a conductor bar made of a single copper material. In other words, according to the present disclosure, it is possible to provide a lightweight rotor with improved electrical conduction performance.

In the rotor for the induction motor according to the embodiment of the present disclosure, the end of the first end ring 30 and the end of the second end ring 40 may be rounded, but the present disclosure is not limited thereto.

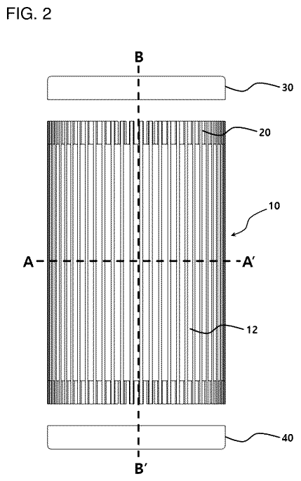

FIG. 2 is a side exploded view of the rotor for the induction motor according to the embodiment of the present disclosure.

Referring to FIG. 2, the rotor may include the rotor core 10 including a body part 12 and a plurality of slots, the conductor bar 20 inserted into the slot, the first end ring 30 coupled to one side of the rotor core 10, and the second end ring 40 coupled to the other side of the rotor core 10.

Auxiliary lines A-A′ and B-B′ shown in the drawing are intended to indicate the cross-sectional direction of the cross-sectional view to be described below, and the auxiliary line B-B′ may be an axis around which the rotor 1 of the present disclosure rotates. An angle formed by the auxiliary line A-A′ and the auxiliary line B-B′ is a right angle.

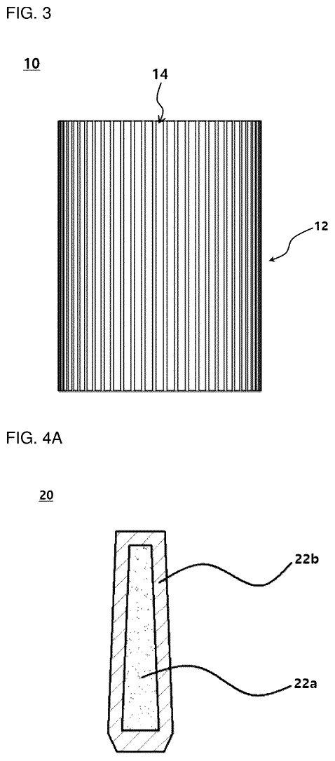

FIG. 3 is a side sectional view of the rotor core of the rotor for the induction motor according to the embodiment of the present disclosure.

Referring to FIG. 3, the rotor core 10 may include the body part 12 and a plurality of slots 14. The body part 12 may have a hollow cylindrical shape formed around the rotation axis.

The plurality of slots 14 may be disposed at predetermined intervals along the outer circumferential surface of the body part 12. A predetermined area extending from one end of the body part to the other end thereof may be formed to be recessed toward the rotation axis of the body part. The shape of the slot 14 is not particularly limited and may correspond to the shape of the conductor bar to be described below.

The material of the rotor core is not particularly limited. A general iron core material may be used for a motor, which has low iron loss and is easily magnetized. In order to apply the rotor core to the rotor for the induction motor, a rotor shaft (not shown) may be assembled in the hollow of the body part. The rotor shaft may transmit rotational force to the body part to rotate the rotor core.

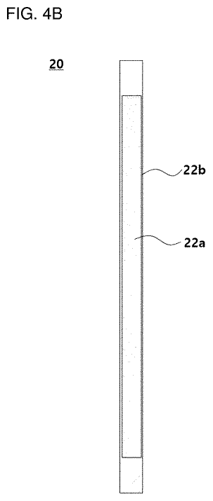

FIG. 4A is a horizontal sectional view (A-A′) of the conductor bar according to an embodiment of the present disclosure. Referring to FIG. 4A, the conductor bar 20 may include a wick 22a and a sealing layer 22b surrounding the wick. Specifically, the wick 22a may include a first metal and have a predetermined shape, and the sealing layer 22b may surround the entire surface of the wick. The horizontal sectional shape of the wick 22a according to one specific embodiment may be trapezoidal but is not limited thereto. The sealing layer according to one specific embodiment may be a polygonal shape surrounding the entire surface of the trapezoidal wick but is not limited thereto. The shapes of the wick and the sealing layer may be appropriately determined according to a manufacturing method of the conductor bar, performance required for the rotor for the induction motor, and the like.

The wick 22a may include a first metal, and the sealing layer 22b may include a second metal. The first metal and the second metal may be the same or different from each other. In one specific embodiment, the first metal may be aluminum (Al), and the second metal may be copper (Cu).

The melting point of the first metal may be about 680° C., but is not limited thereto.

The melting point of the second metal may be about 1080° C., but is not limited thereto.

In one specific embodiment, the impedance of the conductor bar 20 may be in a range of 0.11 to 0.23 mΩ.

In one specific embodiment, the average density of the conductor bar 20 may be in a range of 2.8 to 8.9 g/cm3.

FIG. 4B is an axial sectional view (B-B′) of the conductor bar according to the embodiment of the present disclosure. Referring to FIG. 4B, the sealing layer 22b may surround the entire surface of the wick 22a. The sealing layer 22b may extend from the wick 22a by a predetermined length in the axial direction, which utilizes the skin effect. Here, an aluminum-copper composite material may be applied to the conductor bar of the rotor for the induction motor, thereby making it possible not only to obtain electrical conductivity higher than that of an aluminum conductor bar and improve motor efficiency, but also to have a weight lighter than that of a copper conductor bar.

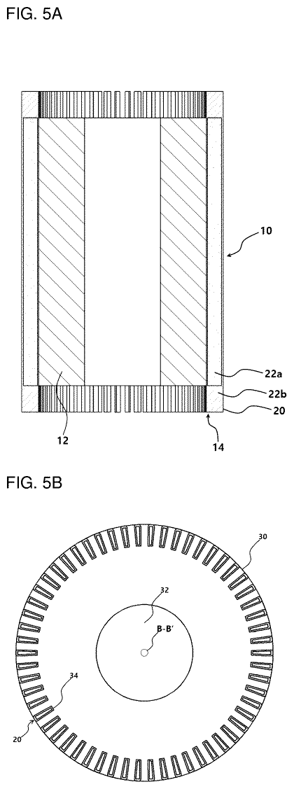

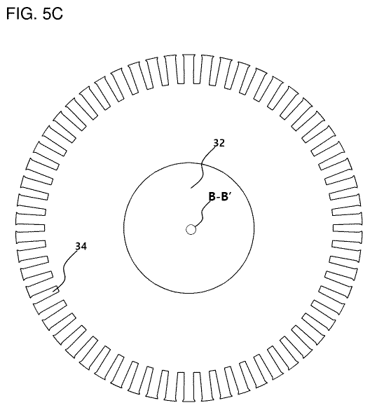

FIG. 5A is an axial sectional view (B-B′) of the rotor core into which the conductor bar is inserted according to an embodiment of the present disclosure. Referring to FIG. 5A, the conductor bar 20 including the wick 22a and the sealing layer 22b surrounding the wick 22a may be inserted into the slot 14 recessed into the surface of the body part 12 of the rotor core 10 having a hollow cylindrical shape. In one specific embodiment, the plurality of slots 14 may be radially disposed along the outer circumferential surface of the body part 12 of the rotor core 10. Accordingly, the conductor bar 20 may be radially inserted along the outer circumferential surface of the body part 12.

FIG. 5B is a top view of the rotor for the induction motor into which the conductor bar is inserted according to one embodiment of the present disclosure. Referring to FIG. 5B, the first end ring 30 may be coupled to one side of the rotor core. The first end ring 30 may have the communication hole 32 configured to allow the rotation axis B-B′ to pass through the central portion thereof. Further, the first end ring 30 may have a ring shape. The first end ring 30 may include a conductor bar coupling groove 34 formed to be recessed corresponding to the shape of the conductor bar 20. In other words, the shape in which the conductor bar coupling groove 34 is recessed may be substantially the same as the shape in which the plurality of slots 14 described above are recessed in the rotor core 10. The conductor bar 20 may be inserted into the conductor bar coupling groove 34.

FIG. 5C is a top view in which the conductor bar is removed from the first end ring of the rotor for the induction motor of the present disclosure. Referring to FIG. 5C, the first end ring may have a ring shape with the hollow communication hole 32 through which the rotation axis B-B′ passes, and the same may have the conductor bar coupling groove 34 formed to be recessed along the outer circumferential surface thereof.

The second end ring 40 included in the rotor of the present disclosure may have the same shape and function as those of the first end ring 30. Therefore, redundant description of substantially the same components between the first end ring 30 and the second end ring 40 are omitted to avoid complexity in the present specification. The conductor bar coupling groove 34 may be divided into a through groove or a recessed groove depending on the length of the conductor bar 20 relative to the length of the rotor core 10 as follows.

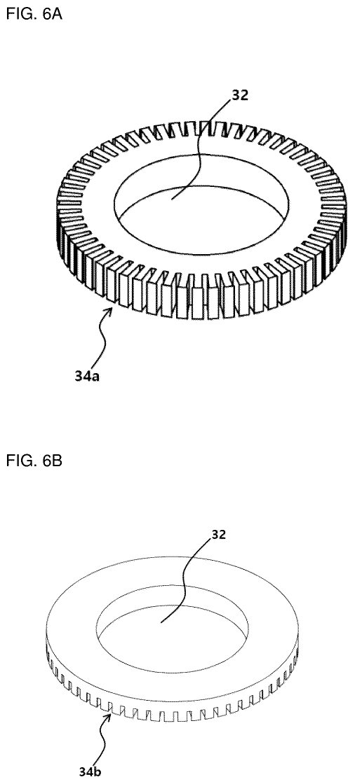

FIG. 6A is a perspective view of a first end ring according to one specific embodiment of the present disclosure.

Referring to FIG. 6A, the first end ring 30 according to one specific embodiment of the present disclosure may include the communication hole 32 and a first through groove 34a. The first through groove 34a may be formed throughout the entire thickness of the first end ring. In first through groove 34a, when the length of the conductor bar 20 corresponds to the length of the rotor core 10, the first end ring 30, and the second end ring 40 in the direction of the rotation axis, one end of the conductor bar 20 may protrude from the rotor core 10. Accordingly, the first through groove 34a may be formed to be recessed corresponding to one end of the protruding conductor bar 20. The second end ring 40 may also include a second through groove 36a formed to be recessed corresponding to the other end of the conductor bar 20. Since the second through groove 36a is symmetrical to the first through groove 34a, a description of the configuration of the second through hole 36a, which is the same as the first through hole 34a, is omitted.

FIG. 6B is a perspective view of a first end ring according to another specific embodiment of the present disclosure.

Referring to FIG. 6B, a first end ring 30 according to another specific embodiment of the present disclosure may include the communication hole 32 and a first recessed groove 34b. The first recessed groove 34b may be recessed over a part of the thickness of the first end ring. In the first recessed groove 34b, when the length of the conductor bar 20 is longer than the length of the rotor core 10 in the direction of the rotation axis, but the same does not reach the length of the first end ring 30 and the second end ring 40 in the direction of the rotation axis, one end of the conductor bar 20 may protrude from the rotor core 10 by a predetermined length. Accordingly, in order to form the first recessed groove 34b, a part of the outer circumferential surface of the first end ring may be formed to be recessed corresponding to one end of the conductor bar 20, the one end protruding from the rotor core 10 by a predetermined length. The second end ring 40 may also include a second recessed groove 36b formed to be recessed corresponding to the other end of the conductor bar 20 formed to protrude by a predetermined length. Since the second recessed groove 36b is symmetrical to the first recessed groove 34b, a description of the configuration of the second recessed groove 36b, which is the same as the first recessed groove 34b, is omitted.

The conductor bar 20 according to the present disclosure may be longer than the length of the rotor core 10 in the direction of the rotation axis. Through this configuration, the conductor bar 20 may be coupled to the first end ring 30 and the second end ring 40 in a sawtooth structure, thereby increasing physical rigidity of the rotor according to the present disclosure.

In addition, the conductor bar 20 may further include a filler metal on at least one surface thereof in contact with the first end ring 30. Specifically, the conductor bar 20 may further include the filler metal at one end thereof in the longitudinal direction.

The filler metal may be based on silver (Ag), copper (Cu), zinc (Zn), cadmium (Cd), nickel (Ni), or the like, and may include, for example, silver and copper.

The melting point of the filler metal may be 670-850° C., and in one specific embodiment, the melting point of the filler metal may be in a range of 750° C. to 800° C.

In one specific embodiment, the filler metal may be melted at one end of the conductor bar 20 in the longitudinal direction to join one side of the conductor bar 20 to the first end ring 30. The filler metal may be melted at the other end of the conductor bar 20 in the longitudinal direction to join the other side of the conductor bar 20 to the second end ring 40. Through this configuration, it is possible to further increase physical rigidity of the rotor according to the present disclosure. In other words, the rotor of the present disclosure may have further increased rigidity through a sawtooth-type physical coupling method and a chemical coupling method using a filler metal.

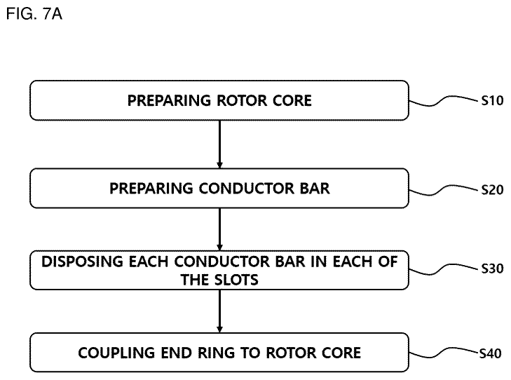

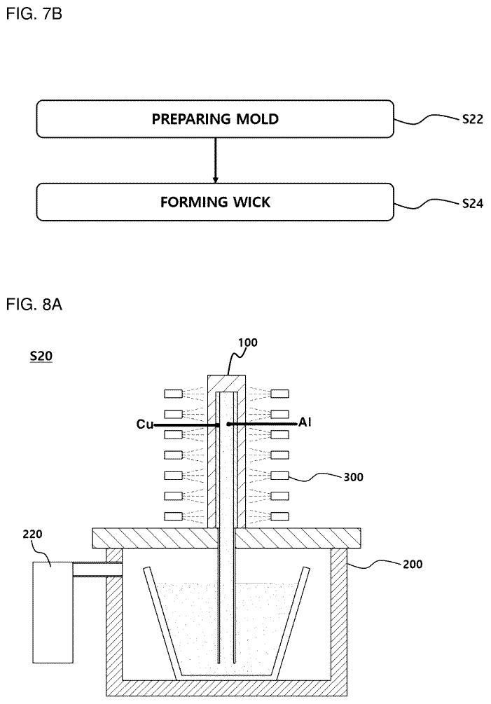

FIG. 7A is a flowchart showing a method of manufacturing the rotor for the induction motor according to the embodiment of the present disclosure. Referring to FIG. 7A, the manufacturing method of the present disclosure may include a step of preparing the rotor core (S10), a step of preparing the conductor bars (S20), a step of disposing each of the conductor bars in a corresponding one of the plurality of slots (S30), and a step of coupling the end ring to the rotor core (S40).

The step of preparing the rotor core (S10) may be a step of preparing the rotor core 10 including a hollow cylindrical body part and a plurality of slots disposed at predetermined intervals along an outer circumferential surface of the body part, the plurality of slots being formed to be recessed toward a rotation axis of the body part in a predetermined area thereof extending from one end of the body part to the other end thereof.

The step of preparing the conductor bars (S20) is a step of preparing the conductor bars, each of which has a rod shape of a predetermined length corresponding to the inner circumferential surface of the slot and is inserted into a corresponding one of the plurality of slots. This step is shown in FIG. 7B to be described below.

The step of preparing the rotor core (S10) may be performed before the step of preparing the conductor bars (S20), but is not limited thereto, and may be performed simultaneously or later.

The step of disposing each of the conductor bars in a corresponding one of the plurality of slots (S30) may be a step of press-fitting each of the prepared conductor bars 20 to be engaged with a corresponding one of the plurality of slots 14 of the rotor core 10.

The step of coupling the end ring to the rotor core (S40) may be a step of coupling the ring-shaped first end ring having the communication hole configured to allow the rotation axis to pass through the central portion thereof to one side of the rotor core and coupling the second end ring symmetrical to the first end ring to the other side of the rotor core. In this case, a filler metal may be used in this coupling step. In addition, the step of coupling the end ring to the rotor core (S40) may be a step of achieving the above-described coupling by melting the filler metal without melting the first end ring 30 and the rotor core 10, which are base metals, through a high-frequency induction heating brazing process.

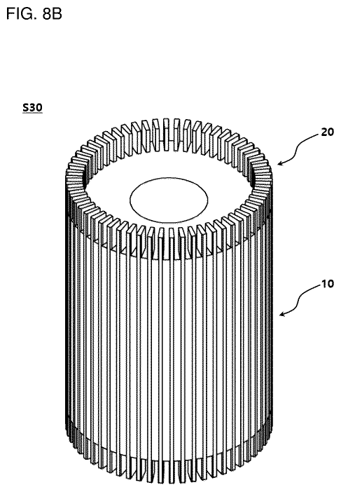

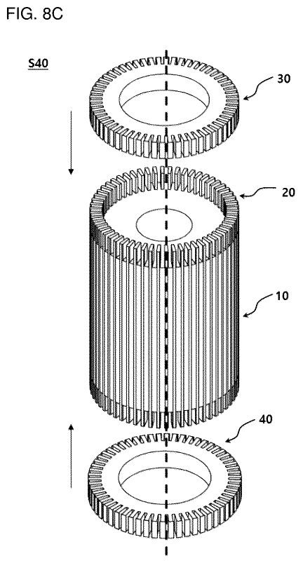

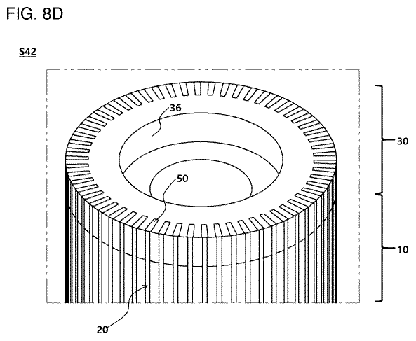

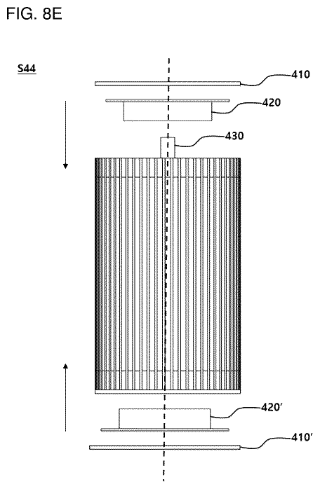

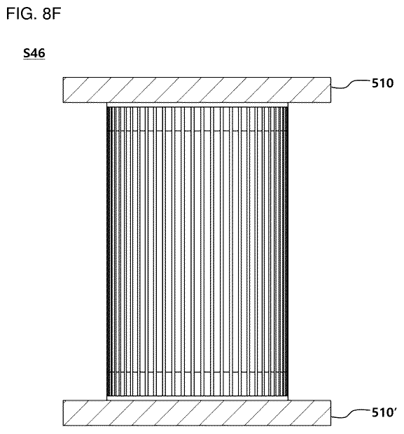

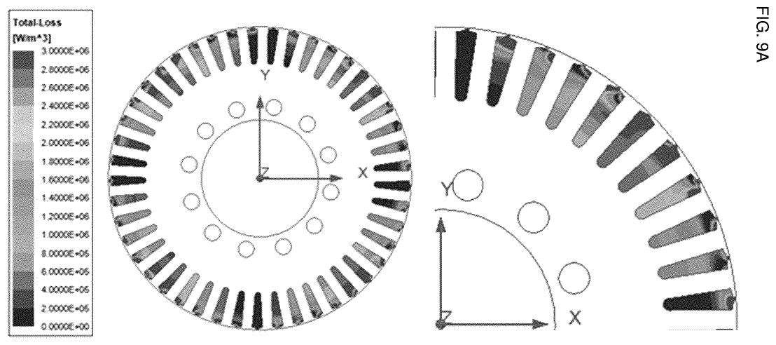

FIG. 7B is a flowchart showing steps of preparing the conductor bars according to the embodiment of the present disclosure. Referring to FIG. 7B, the step of preparing the conductor bars (S20) may include a step of preparing a mold 100 (S22) and a step of forming a wick (S24). The step of preparing the conductor bars (S20) is shown in FIG. 8A below.

FIGS. 8A-8F show each step included in the method of manufacturing the rotor for the induction motor according to the embodiment of the present disclosure.

FIG. 8A shows the step (S20) of preparing the conductor bars. The step of preparing the conductor bars (S20) may include a step of preparing the mold 100 including the second metal (S22) and a step of forming a wick by injecting the first metal into the mold 100 using a low-pressure casting method (S24). In one specific embodiment, the second metal may be copper (Cu), and the first metal may be aluminum (Al). The low-pressure casting method may be performed through a pressure 220 communicating with a chamber 200. The pressure 220 may pressurize the molten first metal placed in the chamber 200 toward the mold 100 including the second metal. In addition, the mold 100 may be cooled through a cooler 300.

In the present disclosure, the first metal may have a melting point lower than that of the second metal. Accordingly, even if the first metal melted in the second metal is cast at low pressure, the second metal is not melted, so the conductor bar 20 having a uniform external shape may be prepared.

FIG. 8B shows the step of disposing each of the conductor bars in a corresponding one of the plurality of slots (S30). Each of the conductor bars 20 prepared in the step of preparing the conductor bars (S20) may be press-fitted to be engaged with a corresponding one of the plurality of slots 14 of the rotor core 10. The press-fitting method is not particularly limited and may be performed through various known metal press-fitting processes.

FIG. 8C shows the step of coupling the end ring to the rotor core (S40). Here, the first end ring 30 may be coupled to one side of the rotor core 10 having the conductor bar 20 press-fitted thereinto, and the second end ring 40 may be coupled to the other side of the rotor core 10. A filler metal may be used for the coupling.

FIG. 8D shows the step of using the filler metal in the above-described coupling according to one specific embodiment of the present disclosure (S42). The step of disposing each of the conductor bars in a corresponding one of the plurality of slots (S30) may further include a step of applying the filler metal 50 to one end and the other end of the conductor bar 20 in the longitudinal direction (S42).

Referring to FIG. 8D, the conductor bar 20 according to one specific embodiment may be longer than the length of the rotor core 10 in the direction of the rotation axis, and the first end ring 30 may include a first through groove formed throughout the thickness of the first end ring 30 corresponding to one end of the protruding conductor bar 20. In this case, the filler metal may be applied to one end 50 of the conductor bar 20 in the longitudinal direction. In addition, the filler metal may be applied to the other end of the conductor bar 20 in the longitudinal direction as well. In another specific embodiment, if the other conductor bar 20 includes the first recessed groove 34b formed over a part of the thickness of the first end ring, the filler metal may be applied to one end of the conductor bar 20 in the longitudinal direction and to the first recessed groove 34b.

FIG. 8E shows a process of assembling a jig to the rotor assembled according to one specific embodiment of the present disclosure.

Referring to FIG. 8E, the step of applying the filler metal (S42) may further include a step of assembling a jig including an assembly column and a supporter in order to prevent the applied filler metal 50 from being separated (S44). First, an assembly column 430 may be inserted into the central portion of the rotor core 10. Next, second supports 420 and 420′ and first supports 410 and 410′ may be sequentially stacked and assembled to one end and the other end of the assembly column, respectively, to shield the filler metal.

FIG. 8F shows a high-frequency induction heating brazing process using a filler metal in one specific embodiment of the present disclosure. Referring to FIG. 8F, it may be seen that the filler metal may be melted through a high-frequency induction heating brazing process (S46) in the step of coupling the end ring to the rotor core (S40). Particularly, the high-frequency induction heating brazing process (S46) may be a process of disposing high-frequency induction coils 510 and 510′ at the opposite ends of the rotor and heating the previously applied filler metal. Here, a jig may be utilized, but the present disclosure is not limited thereto. Through the above-described process, only the end ring side may be locally heated to complete the joining process within a short time, and damage to other components such as the rotor core may be minimized.

Here, brazing means a technique of joining two base metals without damaging the base metals. Specifically, brazing may refer to a technique of joining the same type or different types of metals without damaging the base metals by using a filler metal in the range below the melting point of the two base metals to be joined. Brazing may be used in a very wide range of industries such as automobiles, aircraft, electrical and electronic devices. As a result of using the brazing method in the present disclosure, each of the first end ring 30 and the second end ring 40 is strongly coupled to the rotor core 10 and the conductor bar 20. In this case, since elaborate coupling between the components is obtained, there is no need for additional mechanical processing such as grinding or filing. The rotor for the induction motor of the present disclosure having a metallurgical joint at the joint portion may have characteristics such as excellent impact resistance, vibration resistance, airtightness, thermal conductivity, and corrosion resistance.

### Manufacturing Example

The rotor for the induction motor according to one specific embodiment of the present disclosure is manufactured by the manufacturing method shown in FIG. 7A. The length of the conductor bar corresponds to the lengths of the rotor core, the first end ring, and the second end ring in the direction of the rotation axis, and each end ring has a through groove. As a filler metal, a filler metal having contents and components according to a first embodiment in Table 1 below is used.

TABLE 1

| | | | | | | Melting |
|---|---|---|---|---|---|---|
| Types of filler | Ingredients (% by weight) | | | | | point |
| metal | Ag | Cu | Zn | Cd | Others | (° C.) |
| First embodiment | 71~73 | 27~29 | — | — | — | 780~851 |
| First comparative | 39~41 | 29~31 | 26~30 | — | — | 670~780 |
| example | | | | | | |
| Second | 44~46 | 29~31 | 23~27 | — | — | 675~745 |
| comparative | | | | | | |
| example | | | | | | |
| Third | 49~51 | 23~35 | 14~18 | — | — | 690~775 |
| comparative | | | | | | |
| example | | | | | | |
| Fourth | 54~56 | 21~23 | 15~19 | — | Sn | 620~650 |
| comparative | | | | | 4.5~5.5 | |
| example | | | | | | |
| Fifth comparative | 11~13 | 50~52 | 35~39 | — | — | 780~830 |
| example | | | | | | |
| Sixth comparative | 5~7 | 54~56 | 37~41 | — | — | 790~850 |
| example | | | | | | |

Referring to Table 1, the filler metal of the first embodiment (BAg-8) has a silver content of about 71-73%, does not contain zinc, and has a melting point of about 780°−851° C. The first comparative example (BAg-4), the second comparative example (BAg-5), the third comparative example (BAg-6), the fourth comparative example (BAg-7), the fifth comparative example (SBA12), and the sixth comparative example (SBA6) are shown together.

### Experimental Example

### 1. Loss Distribution

The rotor for the induction motor according to one specific embodiment of the present disclosure is manufactured by the manufacturing method shown in FIG. 7A.

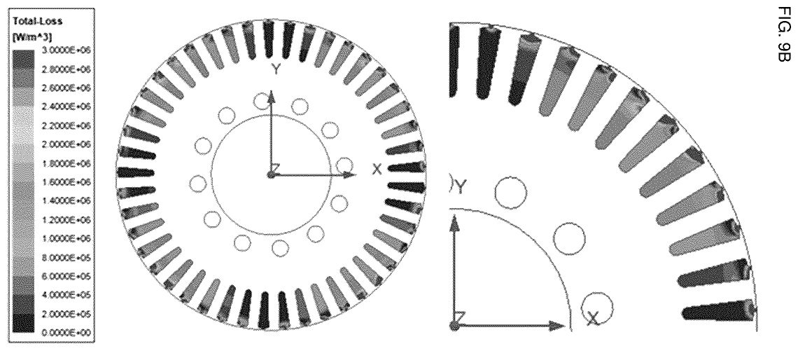

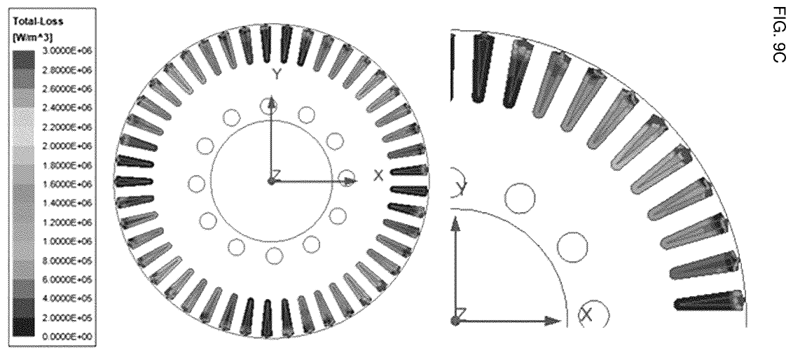

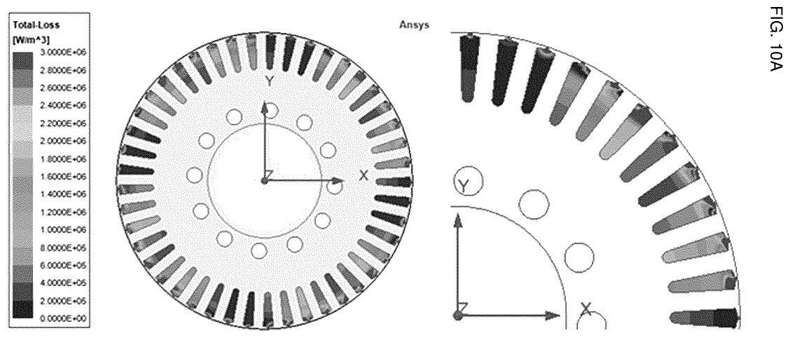

Table 2 and FIGS. 9A-9C show the conditions and results of measuring the loss distribution of each conductor bar of the rotor for the induction motor. FIG. 9A shows a result of using the seventh comparative example (aluminum conductor bar). FIG. 9B shows a result of using a copper conductor bar. FIG. 9C shows a result of using the first embodiment (aluminum-copper composite conductor bar).

TABLE 2

| | | | | Motor |
|---|---|---|---|---|
| | Torque | Speed | Conductor | efficiency |
| Classification | (Nm) | (rpm) | bar loss | (%) |
| Seventh | 110 | 4,000 | 1,831 | 92.8 |
| comparative | | | | |
| example | | | | |
| Eighth | | | 1,270 | 94 |
| comparative | | | | |
| example | | | | |
| First | | | 1,526 | 93.5 |
| embodiment | | | | |

### 2. Current Density

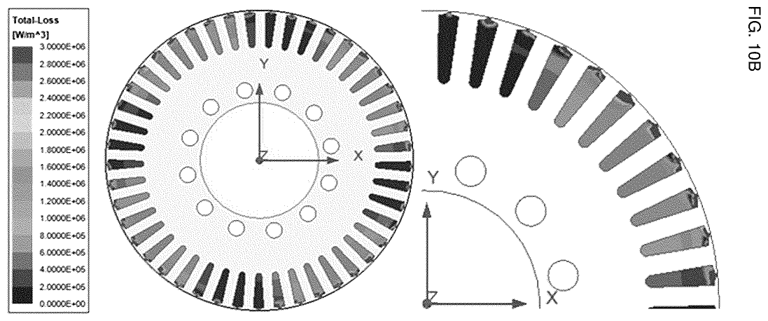

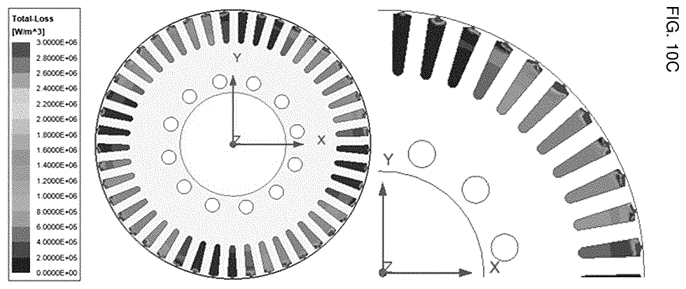

Table 3 and FIGS. 10A-10C show the conditions and results of measuring the current density of each conductor bar of the rotor for the induction motor. FIG. 10A shows a result of using the seventh comparative example (aluminum conductor bar). FIG. 10B shows a result of using the copper conductor bar. FIG. 10C shows a result of using the first embodiment (aluminum-copper composite conductor bar).

TABLE 3

| | | | | Motor |
|---|---|---|---|---|
| | Torque | Speed | Conductor | efficiency |
| Classification | (Nm) | (rpm) | bar loss | (%) |
| Seventh | 61 | 12,500 | 2,389 | 93.6 |
| comparative | | | | |
| example | | | | |
| Eighth | | | 1,884 | 94.6 |
| comparative | | | | |
| example | | | | |
| First | | | 1,684 | 94.3 |
| embodiment | | | | |

In summary, the application of the aluminum-copper composite conductor bar according to the present disclosure may provide a motor with efficiency improvement of 0.7% compared to an aluminum single conductor bar.

### 3. Resistance and Weight Comparison

Table 4 shows the results of measuring the impedance of each conductor bar, the weight of each conductor bar, and the weight of the rotor including 44 conductor bars in the seventh comparative example, the eighth comparative example, and the first embodiment.

TABLE 4

| | Seventh | Eighth | |
|---|---|---|---|
| | comparative | comparative | First |
| | example | example | embodiment |
| Impedance | 0.24 | 0.10 | 0.16 |
| (mΩ) | | | |
| Conductor | 13.67 | 45.05 | 25.98 |
| bar weight | | | |
| (g/unit) | | | |
| Rotor weight | 601.48 | 1982.2 | 1143.12 |

Referring to Table 4, according to the first embodiment of the present disclosure, the aluminum-copper composite conductor bar has a resistance value of only 66% compared to a rotor to which a conventional aluminum single conductor bar is applied. In addition, according to the first embodiment, based on the rotor including 44 conductor bars, it is possible to reduce the weight of about 840 g per rotor compared to a rotor to which a conventional copper single conductor bar is applied, thereby having an effect of reducing the rotor weight.

As is apparent from the above description, the present disclosure provides a rotor for an induction motor using a conductor bar made of an aluminum-copper composite material, and a method of manufacturing the rotor using a casting and a high-frequency induction heating brazing method. The rotor of the present disclosure may have excellent electrical conductivity compared to a rotor to which a conductor bar made of a single aluminum material is applied and may be reduced in weight by about 45% compared to a rotor to which a conductor bar made of a single copper material is applied. In other words, according to the present disclosure, it is possible to provide a motor having improved performance and lightweight.

Furthermore, according to the method of the present disclosure, the high-frequency induction heating brazing method is used. Accordingly, compared to the existing furnace brazing method, the time required to join an end ring to a conductor bar may be significantly reduced, thereby making it possible to shorten process time and reduce process costs.

The effects of the present disclosure are not limited to the above-mentioned effects, and other effects not mentioned herein should be clearly understood by those having ordinary skill in the art from the detailed description of the embodiments.

The disclosure has been described in detail with reference to embodiments thereof. However, it should be appreciated by those having ordinary skill in the art that changes may be made in these embodiments without departing from the principles and spirit of the disclosure, the scope of which is defined in the appended claims and equivalents thereto.

What is claimed is:

1. A rotor for an induction motor, the rotor comprising:
a rotor core comprising a body part having a hollow cylindrical shape and a plurality of slots disposed at predetermined intervals along an outer circumferential surface of the body part, wherein the plurality of slots is formed to be recessed toward a rotation axis of the body part in a predetermined area thereof;
a conductor bar having a rod shape with a predetermined length corresponding to an inner circumferential surface of the plurality of slot, each of the conductor bars being inserted into a corresponding slot of the plurality of slots;
a first end ring coupled to a first side of the rotor core, wherein the first end ring has a ring shape and a communication hole configured to allow the rotation axis to pass through a central portion thereof; and
a second end ring formed to be symmetrical to the first end ring and coupled to a second side of the rotor core,
wherein the conductor bar comprises:
a wick containing a first metal and having a predetermined shape, and
a sealing layer containing a second metal and surrounding an entire surface of the wick.

2. The rotor of claim 1, wherein the first metal is aluminum (Al), and the second metal is copper (Cu).

3. The rotor of claim 1, wherein an impedance of the conductor bar is in a range of 0.11 to 0.23 milliohms (mΩ).

4. The rotor of claim 1, wherein an average density of the conductor bar is in a range of 2.8 to 8.9 grams per centimeter cubed (g/cm³).

5. The rotor of claim 1, wherein the conductor bar further comprises a filler metal at a first end and a second end thereof in a longitudinal direction.

6. The rotor of claim 5, wherein a melting point of the filler metal is in a range of 750 to 800 degrees Celsius (° C.).

7. The rotor of claim 1, wherein the conductor bar protrudes by a predetermined length from opposite ends of the body part in a direction of the rotation axis,
wherein the first end ring comprises a first recessed groove formed to be recessed corresponding to a first end of the conductor bar, and
wherein the second end ring comprises a second recessed groove formed to be recessed corresponding to a second end of the conductor bar.

8. The rotor of claim 1, wherein the conductor bar protrudes by a predetermined length from opposite ends of the body part in a direction of the rotation axis,
wherein the conductor bar further comprises a filler metal at a first end and a second end thereof,
wherein the first end ring comprises a first through groove formed to pass therethrough corresponding to the first end of the conductor bar, and
wherein the second end ring comprises a second through groove formed to pass therethrough corresponding to the second end of the conductor bar.

9. The rotor of claim 1, wherein the wick has a plate shape having a predetermined length and a predetermined width,
wherein the wick has a length equal to or shorter than a length from the first side of the rotor core to the second side thereof, and
wherein the wick has a width equal to or smaller than a depth of each slot of the plurality of slots.

10. A method of manufacturing a rotor for an induction motor, the method comprising:
preparing a rotor core comprising a body part having a hollow cylindrical shape and a plurality of slots disposed at predetermined intervals along an outer circumferential surface of the body part, wherein the plurality of slots is formed to be recessed toward a rotation axis of the body part in a predetermined area thereof extending from a first end of the body part to a second end thereof;
preparing a conductor bar having a rod shape with a predetermined length corresponding to an inner circumferential surface of the plurality of slots, each of the conductor bars being inserted into a corresponding slot of the plurality of slots;
disposing each of the conductor bars in the corresponding slot of the plurality of slots; and
coupling a first end ring having a ring shape and a communication hole configured to allow the rotation axis to pass through a central portion thereof to a first side of the rotor core, and coupling a second end ring formed to be symmetrical to the first end ring to a second side of the rotor core,
wherein the conductor bar comprises a wick containing a first metal and having a predetermined shape and a sealing layer containing a second metal and surrounding an entire surface of the wick.

11. The method of claim 10, wherein the first metal is aluminum (Al), and the second metal is copper (Cu).

12. The method of claim 10, wherein an impedance of the conductor bar is in a range of 0.11 to 0.23 milliohms (mΩ).

13. The method of claim 10, wherein an average density of the conductor bar is in a range of 2.8 to 8.9 grams per centimeter cubed (g/cm³).

14. The method of claim 10, wherein preparing the conductor bar comprises:
preparing a mold containing the second metal; and
forming the wick by injecting the first metal into the mold using a low-pressure casting method.

15. The method of claim 10, wherein the disposing further comprises applying a filler metal to a first end of the conductor bar and a second end thereof in a longitudinal direction.

16. The method of claim 15, wherein a melting point of the filler metal is in a range of 750 to 800 degrees Celsius (° C.).

17. The method of claim 10, wherein the conductor bar protrudes by a predetermined length from opposite ends of the body part in a direction of the rotation axis,
wherein the first end ring comprises a first recessed groove formed to be recessed corresponding to a first end of the conductor bar, and
wherein the second end ring comprises a second recessed groove formed to be recessed corresponding to a second end of the conductor bar.

18. The method of claim 10, wherein the disposing further comprises applying a filler metal to a first end of the conductor bar and a second end thereof in a longitudinal direction,
wherein the conductor bar protrudes by a predetermined length from opposite ends of the body part in a direction of the rotation axis,
wherein the first end ring comprises a first through groove formed to pass therethrough corresponding to the first end of the conductor bar, and
wherein the second end ring comprises a second through groove formed to pass therethrough corresponding to the second end of the conductor bar.

19. The method of claim 10, wherein the coupling is performed by a high-frequency induction heating brazing method.

20. The method of claim 10, wherein the coupling is performed for 10-20 minutes.
